(19) United States
(12) Patent Application Publication
(10) Pub. No.: US 2008/0144673 A1
(43) Pub. Date: Jun. 19, 2008

(54) FIBER LASER WITH LARGE MODE AREA FIBER

(75) Inventor: Valentin P. Gapontsev, Worcester, MA (US)

Correspondence Address: BARLOW, JOSEPHS & HOLMES, LTD., 101 DYER STREET, 5TH FLOOR, PROVIDENCE, RI, 02903, US

(73) Assignee: IPG Photonics Corporation, Oxford, MA (US)

(21) Appl. No.: 11/611,247

(22) Filed: Dec. 15, 2006

(51) Int. Cl. H01S 3/30

(52) U.S. Cl. 372/6

(57) ABSTRACT

A single-mode fiber laser includes a single mode holding, large mode area optical fiber assembly having a large mode area core, a first cladding and a second cladding. The optical fiber assembly has several unique sections including a gain section having a ytterbium-doped core, first and second reflective sections including fiber Bragg gratings that define a lasing cavity, and an absorptive section also having a ytterbium-doped core, the absorptive section having an output end coupled to an input end of said first reflective section. A broad area, multi-mode diode pump source is configured to pump multi-mode light into a tapered input section and cladding-pump the gain section. The gain section absorbs the multi-mode pump light and emits single-mode light. The absorptive section absorbs emissions at the operating wavelength and prevents operating emissions from reflecting back into said pump source.

### BACKGROUND AND SUMMARY OF THE INVENTION

The instant invention relates to fiber lasers and more specifically a multi-mode pumped, single-mode emission fiber laser with large mode area double-clad photonic crystal fiber sections. The fiber laser includes an active fiber section on the pump side of the lasing cavity to absorb back-reflected emissions from the gain section in the lasing cavity.

In particular, the present fiber laser embodiment is preferably configured for end use as a 980 nm pump source for erbium-doped fiber amplifiers. The fiber laser of the present invention includes a ytterbium-doped gain section that absorbs multi-mode pump light at 915 nm and emits single-mode light at an operating wavelength of 970-980 nm, which is ideally suited for pumping an erbium-doped gain medium.

Fiber lasers are defined as a laser with an optical fiber as the gain media. In most cases, the gain medium is a fiber doped with rare-earth ions such as erbium, neodymium, ytterbium, thulium, or praseodymium, and one or several laser diodes are used for pumping of the doped fiber. Fiber laser can be end-pumped or side-pumped. Fiber lasers have many special attractions, particularly for use in the telecommunications field. Some of these special attractions are: a compact and rugged setup, provided that the whole laser cavity is built only with fiber components such as e.g. fiber Bragg gratings and fiber couplers, a large gain bandwidth due to strongly broadened laser transitions in glasses, enabling wide wavelength tuning ranges and/or the generation of ultrashort pulses, broad spectral regions with good pump absorption, making the exact pump wavelength uncritical, diffraction-limited beam quality (when single-mode fibers are used), the potential to operate with very small pump powers, the potential for very high output powers (several kilowatts with double-clad fibers) due to a high surface-to-volume ratio (avoiding excessive heating) and the guiding effect, which avoids thermo-optical problems even under conditions of significant heating, and the ability to operate even on very “difficult” laser transitions (e.g. of up-conversion lasers) due to the ability to maintain high pump intensities over long lengths

On the other hand, fiber lasers can suffer from various problems, such as critical alignment and significant pump losses for launching the pump power (when launching into a single-mode core is required), back reflection of the emission wavelengths into the pump source, complicated temperature-dependent polarization evolution, unless polarization-maintaining fibers or Faraday rotators are used, nonlinear effects which often limit the performance, risk of fiber damage at high powers resulting in fusing of the fiber, and limited gain and pump absorption per unit length, making it difficult to realize short cavity lengths.

The present invention seeks to solve several of the problems commonly encountered in the prior art by utilizing a unique large mode area photonic crystal fiber structure which reduces non-linear effects, and has high gain and pump absorption per unit length, and an active absorptive section between the lasing cavity and the pump source that absorbs the emission wavelength and prevents it from reflecting back into the pump source. The large mode area fiber allows the invention to also takes advantage of inexpensive broad area multi-mode diodes, which have a longer duty life and higher power than single-mode diodes.

All optical fibers experience some signal loss due to attenuation and non-linearities within the fiber itself. Minimizing the effect of these imperfections is critical to maximizing the output power of the laser. To attain higher output power, it is desirable to use optical fibers with a large effective mode area while maintaining single mode guidance. Due to the reduced optical intensities, such fibers effectively have lower non-linearities and a higher damage threshold, which makes them suitable for such applications as the amplification of intense pulses or for single frequency signals, for example.

Conventional single mode fibers can in theory be adapted to provide a large effective mode area. To obtain single-mode guidance despite a large mode area, the numerical aperture of the optical fiber must be decreased, i.e., the refractive index difference between the core and the cladding must be reduced. However, as the numerical aperture decreases the guidance of the fiber weakens and significant losses can arise from small imperfections of the fiber or from bending. Moreover, the fiber may no longer strictly propagate in single-mode, as some higher-order modes may also propagate with relatively small losses. To minimize multi-mode propagation and strengthen the guidance of the fiber, specially optimized refractive index profiles are used, which allow a somewhat better compromise between robust guidance and large mode area. Nevertheless, large mode area single-mode fibers have typically been limited to an effective mode area of about 615 μm² (28 μm mode field diameter).

Large mode area fibers can also be created using photonic crystal fibers (PCFs). Photonic crystal fiber (PCF) (also called holey fiber or microstructure fiber) is an optical fiber, which derives its waveguide properties not from a spatially varying material composition, but from an arrangement of very tiny air holes, which extend longitudinally in a symmetric pattern through the whole length of fiber. Such air holes can be obtained by creating a fiber preform with holes made by stacking capillary tubes (stacked tube technique). Soft glasses and polymers also allow the fabrication of pre-forms for PCF's by extrusion. There is a great variety of hole arrangements, leading to PCF's with very different properties. A typical PCF has a regular array of hexagonally placed air holes surrounding a solid core, which supports guided modes in the solid core by providing a composite cladding consisting of regular air holes in a glass background, the air holes having a lower effective refractive index than that of the core. To reduce the number of guided modes, the state-of-the-art PCF designs employ small air holes with a hole-diameter-to-pitch ratio d/Λ of less than 0.1. In this regime, the PCF is very weakly guiding, leading to a high degree of environmental sensitivity. As a result, robust single-mode propagation in PCFs has also been limited to a MFD of approximately 28 μm, a level similar to that of conventional fiber, which is not surprising considering the similarity in the principle behind the two approaches.

More recent PCF designs have exploited a cladding formed not by a large number of smaller holes, but rather by a limited number of large air holes. The design comprises a solid core surrounded by a ring of very few large air holes with an equivalent hole-diameter-to pitch ratio, d/Λ, larger than 0.7. This large hole cladding PCF design has been demonstrated to provide effective mode areas of up to 1400 μm² (42 μm effective core diameter). This is about 2.5 times higher than for ordinary single-mode fibers or conventional small hole PCF's.

The single-mode fiber laser of the present invention comprises a single mode holding, large mode area photonic crystal fiber assembly having a large mode area silica core, a first silica cladding and a second air channel cladding. Preferably, the second cladding comprises a circular layer of coaxial channels having a very low refractive index as compared to the core and the first cladding such that the first cladding has a relatively high numerical aperture (NA>0.4). The large change in refractive index between the first cladding and second cladding provides an effective single mode holding waveguide for low loss transmission and pumping of a fiber laser.

The optical fiber assembly has several unique large mode area sections including a gain section having a ytterbium-doped core, first and second reflective sections including fiber Bragg gratings that define a lasing cavity, and an absorptive section also having a ytterbium-doped core. The absorptive section is located on the pump side of the lasing cavity having an output end coupled to an input end of the first reflective section.

A broad area, multi-mode pump source is configured to pump multi-mode light into a large mode area tapered input section. The multi-mode pump light propagates through the fiber assembly, cladding-pumping the gain section and producing a stimulated single-mode emission at the desired operating wavelength. The absorptive section, located between the tapered input section and the first reflective section, absorbs emissions at the operating wavelength and prevents operating emissions from reflecting back into said pump source. On the output end of the large mode area fiber assembly, a tapered transition fiber directs the stimulated single-mode emission from the large mode area core into a smaller diameter single mode core. The output of the tapered transition fiber is coupled to a conventional step-index single-mode output fiber.

Accordingly, among the objects of the instant invention are: the provision of single-mode emission fiber laser having a 980 nm continuum emission ideally suited for pumping erbium-doped gain media; the provision of a single-mode fiber laser that utilizes a high-power (1-10 W), broad-area, multi-mode pump source to cladding pump a large mode area fiber and produce a high-power single-mode stimulated emission; and the provision of a fiber laser having an active fiber section on the pump side of the lasing cavity to absorb emissions in the operating wavelength and prevent them from reflecting back into the pump source.

Other objects, features and advantages of the invention shall become apparent as the description thereof proceeds when considered in connection with the accompanying illustrative drawings.

### DESCRIPTION OF THE DRAWINGS

In the drawings which illustrate the best mode presently contemplated for carrying out the present invention:

FIG. 1 is a schematic illustration of the preferred embodiment of the present invention;

FIG. 2 is a cross-sectional view thereof taken along line 2-2 of FIG. 1;

FIG. 3 is another cross-sectional view thereof showing the refractive index profile of the fiber; and

FIG. 4 is a longitudinal cross-sectional view thereof.

### DESCRIPTION OF THE PREFERRED EMBODIMENT

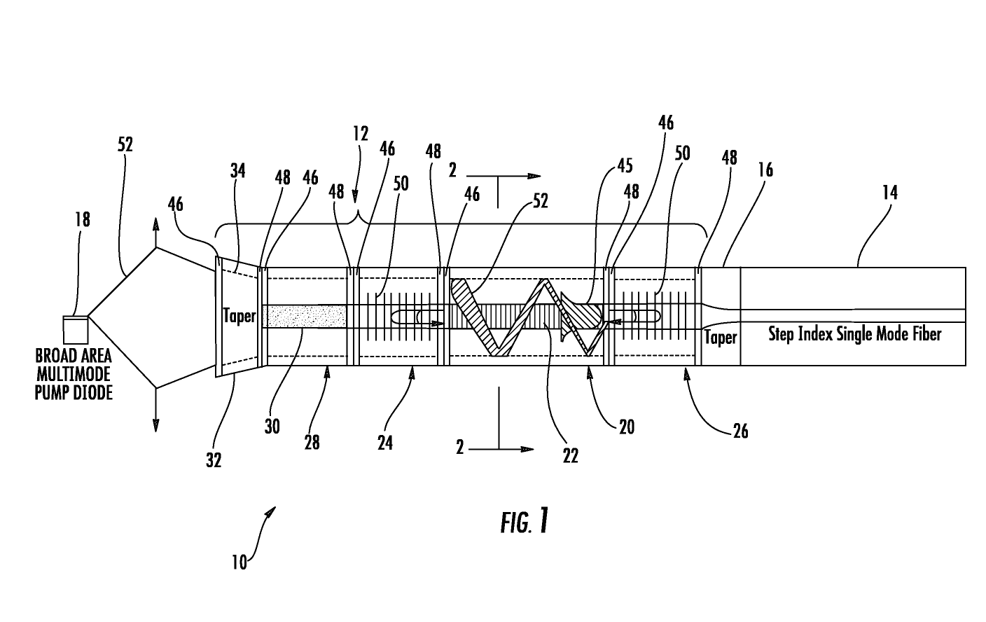

Referring now to the drawings, the fiber laser of the instant invention is illustrated and generally indicated at 10 in FIG. 1. As will hereinafter be more fully described, the preferred embodiment of the present fiber laser 10 is illustrated and described herein for end use as a 980 nm pump source for an erbium-doped fiber device, such as a fiber amplifier. More specifically, the fiber laser 10 of the present invention includes ytterbium-doped gain media that absorbs pump light at 915 nm and emits light at an operating wavelength of 970nm-980 nm, which is ideally suited for pumping an erbium-doped gain medium. While there are specific preferred embodiments described herein, it is contemplated that the teachings of the present invention can be applied to other fiber systems and gain media, and the descriptions herein are thus not intended to limit the scope of the invention.

Referring to FIG. 1, the single-mode fiber laser 10 comprises a single mode holding, large mode area photonic crystal fiber assembly generally indicated at 12, a step-index single mode output fiber generally indicated at 14, a tapered transition fiber generally indicated at 16, and a pump source generally indicated at 18. The large mode area fiber assembly 12 comprises a plurality of discrete fiber sections including a gain section 20 having a Ytterbium doped core 22, first and second reflective sections 24, 26 surrounding the gain section 20 to define a lasing cavity, an absorptive section 28 having a Ytterbium doped core 30, and a tapered input section 32.

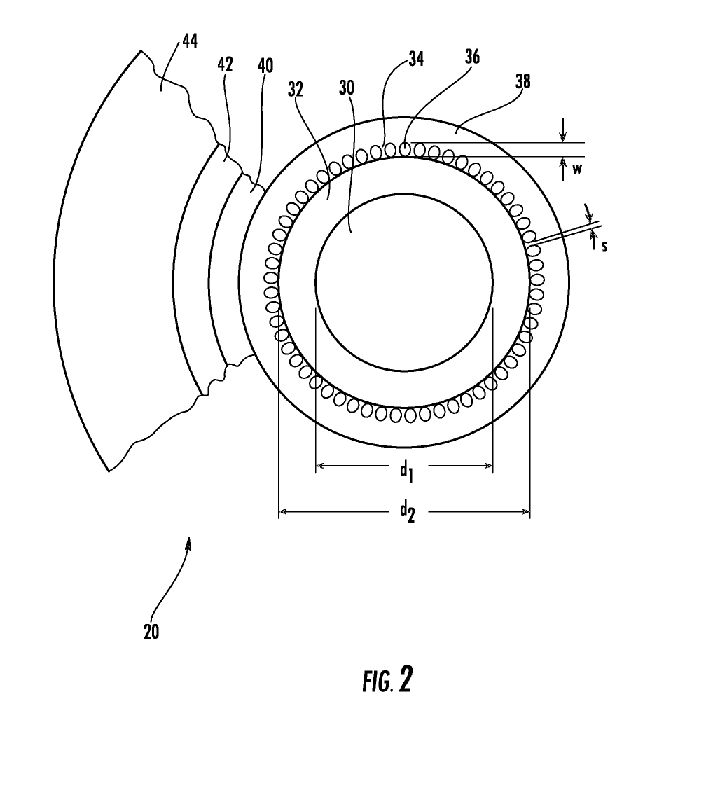

Referring to FIGS. 2-4, each of the sections 20, 24, 26, 28, 32 of the large mode area optical fiber assembly 12 preferably comprises a photonic crystal fiber structure with an air hole cladding layer. In general, photonic crystal fibers with hole structures are known in the art. Photonic crystal fibers are generally constructed from undoped silica glass, but selected portions of the silica glass may contain doping to vary the refractive index thereof or provide active stimulated emissions, i.e. in the core. For purposes of ease of illustration, FIGS. 2-4 depict a cross-sectional view of the gain section 20. Each section is substantially identical in construction, excepting doping of the core and the addition of Bragg gratings, and thus the remaining sections are not specifically illustrated.

More specifically, the optical fiber sections 20, 24, 26, 28 of the present invention each include a large diameter core 30 (up to 60 μm), and a first cladding 32 wherein the difference between refractive index in the core 30 and the first cladding 32 is very small (Δn<0.002) (low contrast boundary), thus providing a very low numerical aperture core (NA between 0.02 and 0.06). The fiber sections each further have a second cladding 34, preferably a layer of air holes 36, having a very low refractive index as compared to the core 30 and first cladding 32 (high contrast) such that the first cladding 32 has a relatively high numerical aperture (NA>0.4). The small change in refractive index between the core 30 and first cladding 32 combined with a large change in refractive index between the first cladding 32 and second cladding 34 provides a significantly improved single-mode holding waveguide for low loss transmission and amplification of single-mode high-power continuous wave and/or pulsed laser power.

As shown in FIG. 2, the large mode field core 30 has a diameter d₁ and the first cladding 32 has a diameter d₂, wherein the ratio of the diameter of the large mode field core to that of the first cladding is effectively less than 2 and more preferably between about 1.3 and about 1.6. Specifically, the fiber sections 20, 24, 26, 28 of the present invention can be constructed with a core diameter d₁ of preferably between about 20 μm and 60 μm. By providing an effective core diameter of up to 60 μm, a mode field area of up to 2800 μm² may be provided. This is a factor of 2 times better than fibers of the prior art. In the embodiment as illustrated, the core has a diameter of approximately 60 μm and the first cladding 14 has a diameter of approximately 110 μm.

The fiber sections 20, 24, 26, 28 each further comprise a third cladding 38, a fourth cladding 40, a fifth cladding 42 and an outer protective jacket 44.

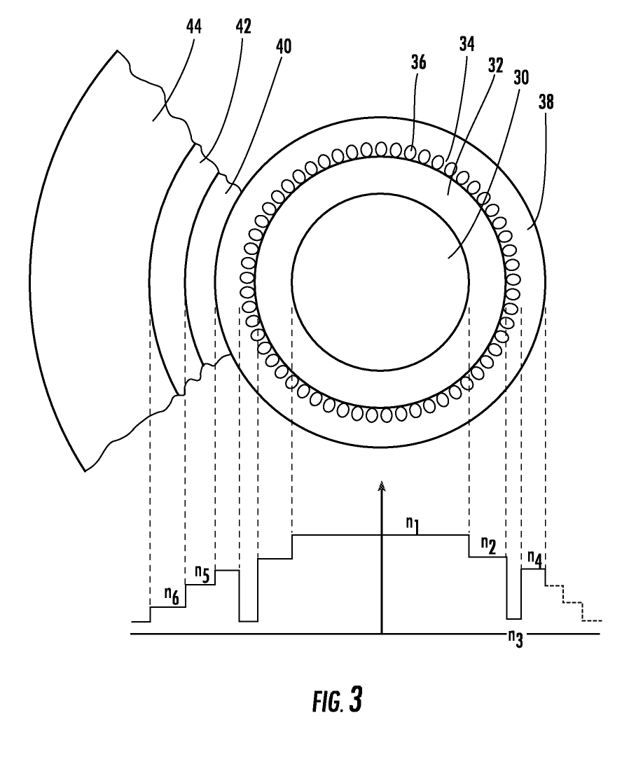

Referring to FIG. 3, the large mode area core 30 has an effective refractive index n₁. Preferably, the large mode area core 30 is formed from silica glass, which is slightly doped to raise the refractive index just above that of the first cladding 32. To obtain the desired refractive index n₁, the large mode area core 30 may be doped for example, with elements from the group comprising P, Ge, F, B, Y, or Al. Other dopants known in the art could be substituted depending on the desired characteristics or application in which the optical fiber section will be used (for example, optimizing for a specific transmission wavelength A). In the case of the active sections 20 and 28, the cores 22 and 30 are also doped with ytterbium to provide stimulated emissions.

Turning back to FIG. 3, the first, or inner, cladding 14 has an effective refractive index n₂, which is just slightly lower than the refractive index n₁ of the large mode area core 30 to create an effective numerical aperture (NA) of between about 0.02 and 0.06. In this regard, the first cladding 32 is also preferably formed of silica glass, which may also be doped to obtain the desired refractive index n₂ and numerical aperture (NA) for the waveguide. A critical aspect for operation is that the change (Δ) in refractive index between the core 30 and the first cladding 32 be very small (Δn<0.002) to create a small numerical aperture. For example, undoped silica glass has a refractive index of about 1.450. If the first cladding, i.e. in reflective sections 26 and 28, is undoped silica, the core 30 in these sections would be slightly doped with trace elements to raise the refractive index to about 1.451

A second cladding layer 34 surrounds the first cladding layer 32. Preferably, the second cladding 34 is formed by a circular ring of coaxial channels 36 spaced uniformly around the first cladding 32 at a pitch s, each coaxial channel having a cross-sectional dimension W (as seen in FIG. 2). The pitch s is preferably selected to be less than two times the transmission wavelength λ. The cross-sectional dimension W is defined as the largest cross-sectional feature of the hole 36. Preferably the dimension W of the coaxial channels 36 is less than five times the transmission wavelength λ. In this case, the holes 36 are slightly oblong, and thus have one cross-sectional dimension greater than the other.

The coaxial channel cladding layer 34 has an effective refractive index n₃, which is much less than the refractive index n₂ of the inner cladding, and preferably n₂ is less than 1.3. By providing a low refractive index (high contrast) cladding structure, the numerical aperture of first cladding 32 is effectively greater than 0.4. As mentioned earlier, it is preferred that the coaxial channels 36 are filled with air, however, other gasses may be used. The channels 36 may also be formed so as to have a vacuum.

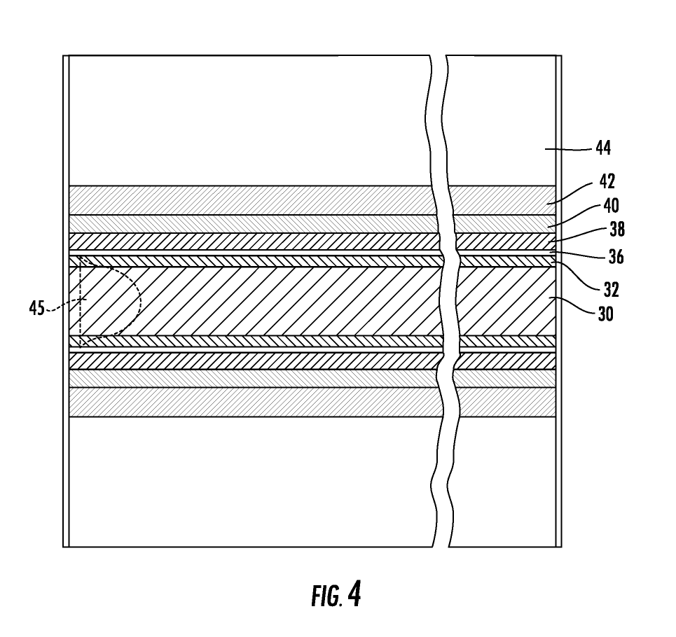

As can be seen in FIG. 4, this arrangement of cladding layers around a large mode area core defines a waveguide wherein the fundamental mode field 45 of the light emission is substantially confined to the large mode area core.

The third cladding layer 38 has a refractive index n₄ wherein n₄>n₃. In the context of a photonic crystal fiber, the third cladding 38 is also preferably a silica glass. Preferably the thickness of the third cladding 38 is about 10 μm-20 μm, although the exact thickness will depend on the material used and the desired fiber characteristics.

Surrounding the third cladding layer 38 are a number of other layers to minimize multimode propagation, outside interference, and provide support and protection for the optical fiber sections.

Specifically, the fourth cladding layer 40 preferably comprises a layer of Silicon Fluoride (SiF) approximately 8-10 μm in thickness and having a refractive index n₅ wherein n₅ is less than n₄. The fourth cladding 40 preferably has an effective numerical aperture of approximately 0.15.

A fifth cladding layer 42 of a fluoropolymer of about 10 μm-20 μm in thickness and refractive index n₆surrounds the fourth cladding 40. Refractive index n₆ is less than refractive index n₅, and provides an effective numerical aperture of about 0.4. The successive drop is refractive index between these cladding layers helps prevent multimode propagation and prevent outside interference.

Protective jacket 44 surrounds the fifth cladding 42 and provides mechanical strength and protection to the optical fiber of the present invention. The jacket 44 will generally have a thickness of approximately 100 μm. The fourth and fifth cladding layers 40, 42 and the jacket 44 comprise conventional cladding materials, which are well known in the art, and the selection of materials and dimensions for these layers is not considered to be critical to the invention outside of the given parameters stated above.

Still referring to FIG. 4, each of the optical fiber sections of the present invention includes end facets 46, 48 located at each end of the optical fiber section. The end facets 46, 48 seal the open ends of the coaxial channels 36 and are preferably less then 100 μm in thickness.

Turning back to FIG. 1, the individual fiber sections 20, 24, 26 and 28 are spliced together as illustrated with the gain section 20 sandwiched between the reflective sections 24, 26. Face-to-face splicing of the end facets 46, 48 of each of the fiber sections 20, 24, 26, 28, 32 provides low-loss air free interfaces between each of the fiber sections for improved transmission.

The gain section 20 is relatively short in length as compared to conventional gain sections of fiber lasers due to the large mode area construction and improved coupling efficiency of the crystal fiber structures. The core 22 of the gain section 20 is doped with ytterbium ions with a doping level and distribution optimized for peak absorption in the 880 nm to 940 nm wavelength range and stimulated emission in the 970 nm to 980 nm wavelength range.

The first and second reflective sections 24, 26 include fiber Bragg gratings 50 having a predefined reflectivity. The creation of Bragg gratings 50 in optical fibers is well known in the art and will not be described further herein.

The Bragg gratings 50 are written into the fiber so that the fiber produces an output at the desired operating wavelength. In this preferred embodiment, the Bragg gratings 50 are optimized for an emission output of 980 nm.

Absorptive section 28 is located on the pump side of the first reflective section 24, and includes an active doped core region 30. The core 30 is preferably doped with ytterbium ions with a doping level and distribution optimized for peak absorption in the 970 nm to 980 nm wavelength range.

Tapered input section 32 is an undoped large mode area fiber pre-form having a larger diameter input end and a smaller diameter output end. The tapered section 32 lacks a core, but does include the air channel cladding layer 34. The output end 48 is spliced to the input end 46 of the first absorptive section 28 for coupling substantially all of the output emissions from the pump source 18 into the fiber assembly.

The broad area, multi-mode pump source 18 is configured to pump multi-mode light 52 into the large mode area tapered input section 32. The pump source 18 preferably comprises a broad area multi-mode laser diode having an output power level in the range of 1-10 W.

In operation, the multi-mode pump light 52 propagates through the fiber assembly 12, cladding-pumping the gain section 20 and producing a stimulated single-mode emission at the desired operating wavelength. The absorptive section 28, located between the tapered input section 32 and the first reflective section 24, absorbs emissions at the operating wavelength and prevents operating emissions from reflecting back into the pump source 18. On the output end of the large mode area fiber assembly 12, the tapered transition fiber 16 directs the stimulated single-mode emission from the large mode area core into a smaller diameter single mode core. The output of the tapered fiber 16 is coupled to the step-index single-mode output fiber 14.

The present fiber laser design provides a high-power, robust single mode emission and propagation of light in a fiber waveguide, with little or no leakage. Among the many benefits provided by this fiber laser design are a significant improvement of peak power with diffraction limited beam quality, a more reliable, longer life, and cost-effective multi-mode pump source, and a more reliable, cost effective signal coupling due to the larger fiber effective area.

It can therefore be seen that the present invention provides a cost-effective single-mode fiber laser having a 980 nm continuum emission ideally suited for pumping erbium-doped gain media, as well as a single-mode fiber laser that utilizes a high-power (1-10 W), broad-area, multi-mode pump source to cladding pump a large mode area fiber and produce a high-power single-mode stimulated emission. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A single-mode fiber laser comprising:
a single mode holding, large mode area optical fiber assembly having a large mode area core, a first cladding and a second cladding,
said optical fiber assembly including
a gain section having a ytterbium-doped core,
a first reflective section having an output end coupled to an input end of the gain section,
a second reflective section having an input end coupled to an output end of said gain section,
said first and second reflective sections including fiber Bragg gratings and defining a lasing cavity having an operating wavelength of between about 960 nm and about 990 nm,
an absorptive section having a ytterbium-doped core, said absorptive section having an output end coupled to an input end of said first reflective section,
a tapered input section having an output end coupled to an input end of said absorptive section;
a step-index single-mode output fiber;
a tapered transition fiber having an input end coupled to an output end of said second reflective section, and an output end coupled to an input end of said output fiber; and
a broad area, multi-mode pump source configured to pump multi-mode light into said tapered input section and cladding pump said gain section,
said pump light having a wavelength of between about 880 nm and about 940 nm wherein said gain section absorbs said multi-mode pump light and emits single-mode light at said operating wavelength,
said absorptive section absorbing emissions at said operating wavelength and preventing said emissions at said operating wavelength from reflecting back into said pump source.

2. The fiber laser of claim 1 wherein the wavelength of said pump light is about 915 nm, and operating wavelength is between about 970 nm and about 980 nm.

3. The fiber laser of claim 1 wherein each of said sections of said single mode holding, large mode area optical fiber assembly comprises:
a core having an effective mode field diameter d1 and an effective refractive index n1, a first cladding having an effective mode field diameter d2 and an effective refractive index n2, wherein
n2<n1, and
d2/d1<2,
said core having an effective core numerical aperture between about 0.02 and about 0.06,
a second cladding having an effective index of refraction n3, wherein
n3<1.3,
n3<n2, and
said first inner cladding having an effective numerical aperture of greater than about 0.4, and
a third cladding having an index of refraction n4, wherein n4>n3,

4. The fiber of claim 3 wherein d2/d1 is between about 1.3 and about 1.6.

5. The fiber of claim 3 wherein d1 is between about 20 μm and about 60 μm.

6. The fiber of claim 3 wherein said second cladding comprises at least one substantially circular layer of coaxial channels.

7. The fiber of claim 6 wherein said coaxial channels are filled with gas.

8. The fiber of claim 6 wherein said channels have a largest cross-sectional dimension W,
wherein W<(5 times λ) and further wherein said channels are circumferentially spaced by a distance s,
wherein s<(2 times λ)
